(19) United States
(12) Patent Application Publication
(10) Pub. No.: US 2011/0303036 A1
(43) Pub. Date: Dec. 15, 2011

(54) Ball return device for ball screw device

(75) Inventors: Yan Yu Chen, Taichung (TW); Yu Pei Chang, Taichung (TW)

(73) Assignee: Hiwin Technologies Corp.

(21) Appl. No.: 13/136,965

(22) Filed: Aug. 16, 2011

Related U.S. Application Data
(63) Continuation-in-part of application No. 12/319,361, filed on Jan. 6, 2009, now abandoned.

(51) Int. Cl. F16H 25/22; F16C 29/06

(52) U.S. Cl. 74/424.83

(57) ABSTRACT

A ball screw device includes a screw engaged into a nut member for forming an endless ball guiding passage and for receiving a number of ball bearing members, a ball return device includes a U-shaped structure having a central carrying member and a protrusion extended out from each end for engaging into the nut member and for increasing the curvature of the ball return pathway of the ball return device, and a return device holder engaged with the protrusions of the ball return device for retaining the ball return device to the nut member and for preventing the ball return device from moving laterally relative to the nut member and for suitably guiding the ball bearing members to smoothly move through the endless ball guiding passages of the ball screw device.

The present invention is a continuation-in-part of U.S. patent application Ser. No. 12/319,361, filed 6 Jan. 2009, pending and to be abandoned.

### BACKGROUND OF THE INVENTION

1. Field of the Invention

The present invention relates to a ball return device for a ball screw device, and more particularly to a ball return device including an anchoring or securing structure or device for suitably anchoring or securing or retaining the ball return device to the ball screw device and for suitably guiding the ball bearing members to smoothly move through the endless ball guiding passages of the ball screw device.

2. Description of the Prior Art

Typical ball screw devices comprise a nut threaded onto an elongated bolt or screw and rotatable and movable or adjustable along the screw, one or more endless ball guiding passages formed in the ball screw device for slidably receiving ball bearing members, and one or more ball return pipes attached onto the ball screw device for guiding the ball bearing members to smoothly and suitably move through the endless ball guiding passages of the ball screw device.

For example, U.S. Pat. No. 4,953,419 to Schlenker discloses one of the typical ball screw return systems also comprising a ball return pipe engaged onto a nut for guiding the ball bearing members to smoothly move through the endless ball guiding passage of the ball screw and nut combination, and a pair of tube support flanges positioned along the nut for solidly securing the ball return pipe to the nut.

However, the ball return pipe should be highly supported above the nut with the tube support flanges, and may not be closely secured to the nut. In addition, two or more sharp returning angles or curvatures will be formed in the endless ball guiding passage of the ball return pipe such that the ball bearing members may not be smoothly moved through the endless ball guiding passage of the ball screw and nut combination.

U.S. Pat. No. 5,063,809 to Schlenker discloses another typical ball screw and nut assembly also comprising a ball return pipe engaged or attached or secured onto a nut with a standard hose clamp for guiding the ball bearing members to smoothly move through the endless ball guiding passage of the ball screw and nut assembly.

However, for smoothly or swiftly guiding or deflecting the ball bearing members, the ball return pipe should also be highly supported above the nut and may not be closely secured to the nut. In addition, two or more sharp returning angles or curvatures will be formed in the endless ball guiding passage of the ball return pipe such that the ball bearing members may not be smoothly moved through the endless ball guiding passage of the ball screw and nut combination.

U.S. Pat. No. 6,023,991 to Yabe et al. discloses a further typical ball screw device also comprising a ball return pipe engaged onto the ball screw nut with a tube holder member and fasteners for guiding the ball bearing members to smoothly move through the endless ball guiding passage of the ball screw device, and the ball return pipe include two tubular tongues formed in the ends for engaging into the nut.

However, the ball return pipe may not be precisely secured to the nut and the tubular tongues of the ball return pipe may not be precisely directed toward the endless ball guiding passage of the ball screw device. In addition, two or more 90-degree returning angles or sharp-angle curves or curvatures will be formed in the endless ball guiding passage of the ball return pipe such that the ball bearing members may not be smoothly and swiftly moved through the endless ball guiding passage of the ball screw and nut combination.

U.S. Pat. No. 6,481,305 to Nishimura et al. discloses a further typical ball screw device also comprising one or more ball return pipes attached onto the ball screw nut and each having two bent tubular ends engaged into the ball screw nut for guiding the ball bearing members to smoothly move through the endless ball guiding passage of the ball screw device.

However, the ball return pipe may not be precisely secured to the nut, and the tubular ends of the ball return pipe may not be precisely guided or directed toward the endless ball guiding passage of the ball screw device. In addition, two or more 90-degree returning angles or sharp-angle curves or curvatures will be formed in the endless ball guiding passage of the ball return pipe such that the ball bearing members may not be smoothly and swiftly moved through the endless ball guiding passage of the ball screw and nut combination.

As shown in FIGS. 9-11, the typical ball screw devices normally comprise one or more ball return pipes attached onto the ball screw nut and each having two bent tubular ends engaged into the ball screw nut for guiding the ball bearing members to smoothly move through the endless ball guiding passage of the ball screw device.

However, the curved or bent portions of the ball return pipes each comprise a 90-degree or more returning angle or sharp-angle curve or curvature formed in the endless ball guiding passage of the ball return pipe (FIGS. 9, 10) such that the ball bearing members may not smoothly move through the endless ball guiding passage of the ball screw device; or, the ball screw nut has no space to receive or engage with the sharp-angle end portions of the ball return pipes (FIG. 11) such that the strength of the ball screw nut will be greatly decreased.

may not be precisely secured to the nut, and the tubular ends of the ball return pipe may not be precisely guided or directed toward the endless ball guiding passage of the ball screw device. In addition, two or more such that the ball bearing members may not be smoothly and swiftly moved through the endless ball guiding passage of the ball screw and nut combination.

The present invention has arisen to mitigate and/or obviate the afore-described disadvantages of the conventional ball return pipes for the ball screw devices.

### SUMMARY OF THE INVENTION

The primary objective of the present invention is to provide a ball return device including an anchoring or securing structure or device for suitably anchoring or securing or retaining the ball return device to the ball screw device and for suitably guiding the ball bearing members to smoothly move through the endless ball guiding passages of the ball screw device.

The other objective of the present invention is to provide a ball return device including an increased returning angle or curvature formed in the endless ball guiding carrying of the ball return device for allowing the ball bearing members to smoothly or effectively move through the endless ball guiding carrying of the ball return device.

In accordance with one aspect of the invention, there is provided a ball screw device comprising a nut member including a screw hole formed therein and defined by a number of helical grooves, and including two orifices formed in the nut member and communicating with the helical grooves of the nut member, the nut member including two notches formed therein and communicating with the orifices of the nut member respectively, an elongated screw engaged into the screw hole of the nut member and including a number of helical grooves for engaging with the helical grooves of the nut member and for forming an endless ball guiding passage between the nut member and the screw, a number of ball bearing members engaged in the endless ball guiding passage of the ball screw device, and a ball return device including a U-shaped structure having a central carrying member and two ends, and having two curved coupling portions formed between the central carrying member and the ends, and having a protrusion extended outwardly from each of the ends for engaging into the orifices of the nut member, each of the protrusions including an inner surface and an outer surface, and the ball return device including a ball return pathway formed therein and communicating with the helical grooves and the endless ball guiding passage of the nut member for slidably receiving the ball bearing members, the ball return pathway of the ball return device being curved in each of the protrusions for communicating with the helical grooves and the endless ball guiding passage of the nut member, the notches of the nut member being engaged with the curved coupling portions of the ball return device, and the ball return pathway of the ball return device being curved in the protrusions at the ends of the ball return device, and the ball return device including a lower U-shaped supporting element and an upper U-shaped supporting element each having one half of the ball return pathway formed therein, the protrusions of the ball return device each including a cutting surface formed therein for separating the protrusion into two protrusion segments, and the upper and the lower supporting elements each including the protrusion segments formed at end portions thereof, the curved coupling portions of the upper supporting element each including a portion of the upper surface of the protrusion formed therein, and the curved coupling portions of the lower supporting element each including the inner surface of the protrusion formed therein.

The nut member includes an upper surface, and the upper surfaces of the protrusions are aligned with the upper surface of the nut member. The nut member includes a cut off portion formed in an upper portion thereof and defined by the upper surface of the nut member.

The orifices of the nut member are communicating with the cut off portion of the nut member. The curved coupling portions of the ball return device are engaged into the orifices of the nut member and located below the upper surface of the nut member.

A return device holder may further be provided and may include a planar member engaged onto the nut member and engaged with the protrusions of the ball return device for retaining the ball return device to the nut member and for preventing the ball return device from moving laterally relative to the nut member.

The return device holder includes a retaining member having a compartment formed therein for receiving the central carrying member. The curved coupling portions of the upper supporting element each include a portion of the cutting surface of the protrusion formed therein.

The curved coupling portions of the lower supporting element each include a portion of the cutting surface of the protrusion formed therein. The protrusions of the upper supporting element each include the outer surface formed therein.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a ball screw device including two ball return devices in accordance with the present invention;

FIG. 2 is a perspective view of the ball screw device;

FIG. 3 is another perspective view of the ball return device, in which the outer environment of the ball screw device including the central elongated bolt or screw and the outer nut member has been shown in dotted lines for illustrating the operation of the ball return device for the ball screw device;

FIG. 4 is a cross sectional view of the ball screw device taken along lines 4-4 of FIG. 2; and

FIG. 5 is an enlarged partial cross sectional view of the ball return device and the ball screw device;

FIG. 6 is a perspective view of a ball return device of the ball screw device;

FIG. 7 is a plan schematic view of the ball return device of the ball screw device;

FIG. 8 is a partial plan schematic view of the ball return device of the ball screw device;

FIG. 9 is a cross sectional view illustrating one example of the ball return device of one of the typical ball screw devices;

FIG. 10 is another cross sectional view illustrating the other ball return device of the typical ball screw device; and

FIG. 11 is a further cross sectional view illustrating the further ball return device of the typical ball screw device.

### DETAILED DESCRIPTION OF THE PREFERRED EMBODIMENT

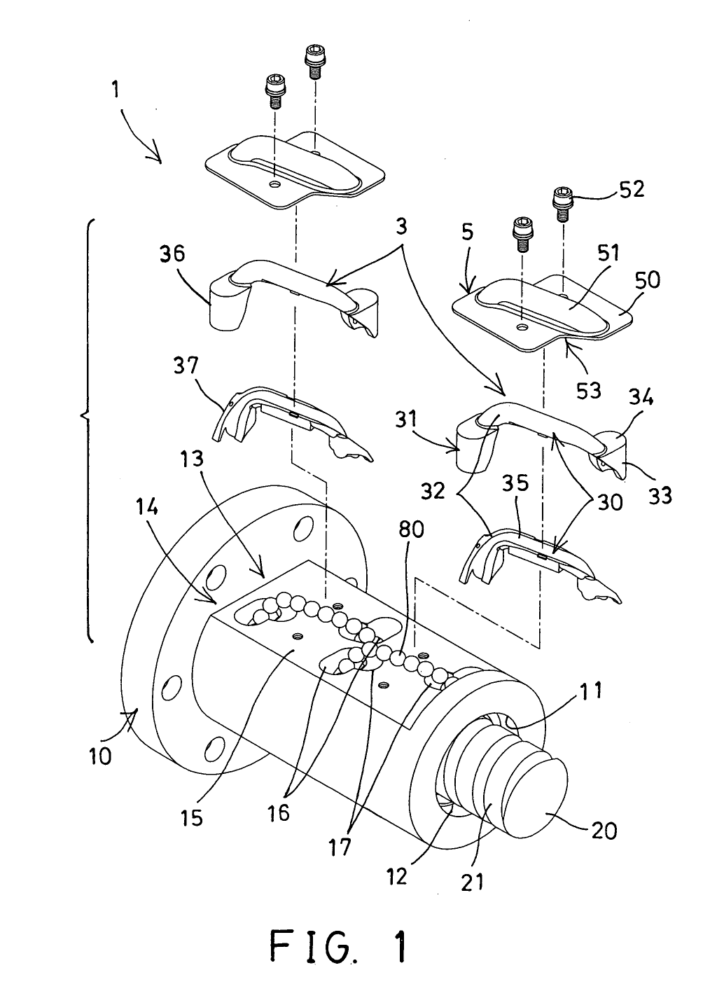

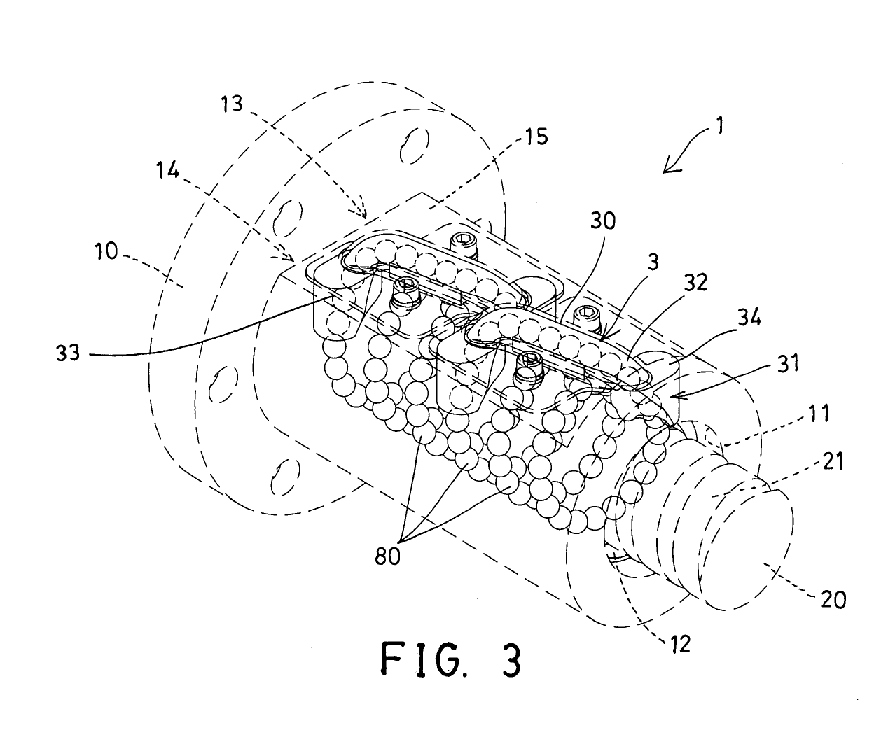

Referring to the drawings, and initially to FIGS. 1-4, a ball screw device 1 in accordance with the present invention comprises a nut member 10 including a screw hole 11 formed therein and formed or defined by a number of helical threaded portions or grooves 12, and an elongated bolt or screw 20 engaged into the screw hole 11 of the nut member 10 and including a number of helical threaded portions or grooves 21 for threading or engaging with the helical threaded portions or grooves 12 of the nut member 10 and for allowing the nut member 10 to be rotated and moved or adjusted along the screw 20, and for forming one or more endless ball guiding passages 22 in the ball screw device 1 or between the nut member 10 and the screw 20 and for slidably receiving a number of ball bearing members 80.

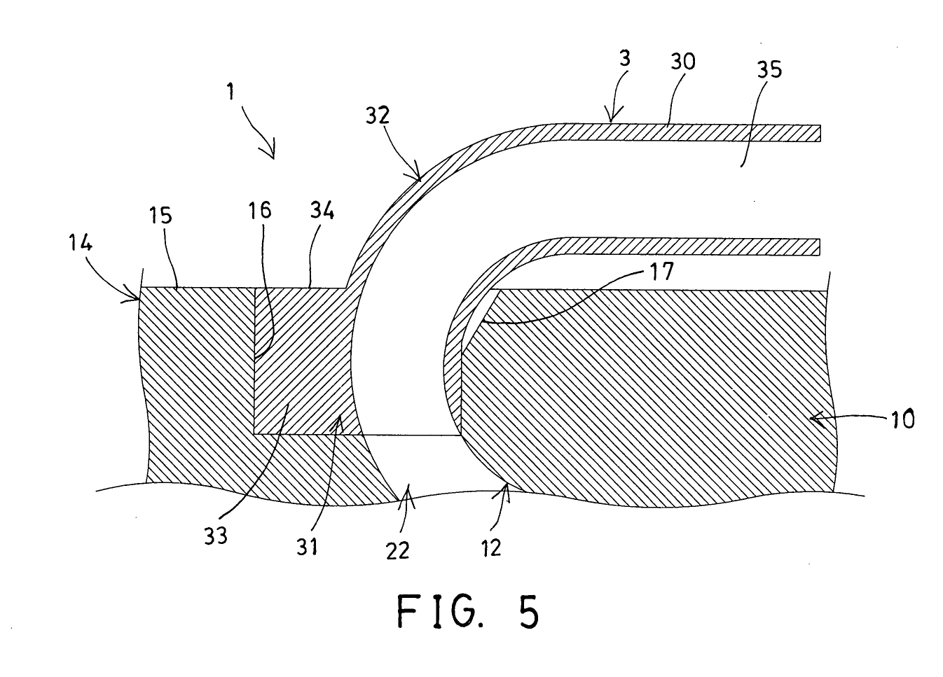

The nut member 10 includes a cut off portion 13 formed therein, such as formed in the upper portion 14 thereof, and formed or defined by an upper flat surface 15, and includes one or more (such as two) pairs of orifices 16 formed in the upper portion 14 of the nut member 10 and communicating with the cut off portion 13 and the helical grooves 12 and/or the endless ball guiding passages 22 of the nut member 10 (FIGS. 1 and 4-5), and includes one or more notches 17 also formed in the upper portion 14 of the nut member 10 and communicating with the cut off portion 13 and the orifices 16 of the nut member 10 respectively (FIG. 5). The coupling or threading structure or the engagement between the nut member 10 and the screw 20 is typical and will not be described in further details.

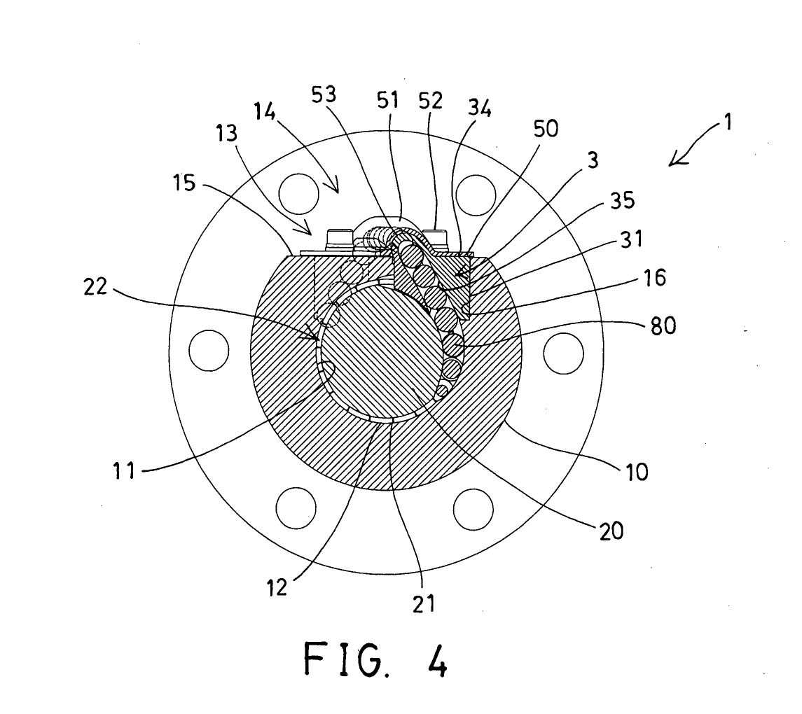

One or more (such as two) ball return devices 3 each include a substantially U-shaped structure or configuration having a central elongated carrying member 30, and having two ends 31, and having two curved intermediate or coupling portions 32 located or formed between the central carrying member 30 and the ends 31, and having an enlarged protrusion 33 extended outwardly from each end 31 for engaging into the orifices 16 of the nut member 10, the enlarged protrusions 33 at the ends 31 of each ball return device 3 include a volume or dimension or outer diameter greater than that of the carrying member 30, and each include an upper portion or surface 34 aligning or flushing with the upper flat surface 15 of the nut member 10, best shown in FIGS. 4 and 5, and the ball return devices 3 each include a ball return pathway 35 formed therein and communicating with the helical grooves 12 and/or the endless ball guiding passages 22 of the nut member 10 of the ball screw device 1 for slidably receiving the ball bearing members 80.

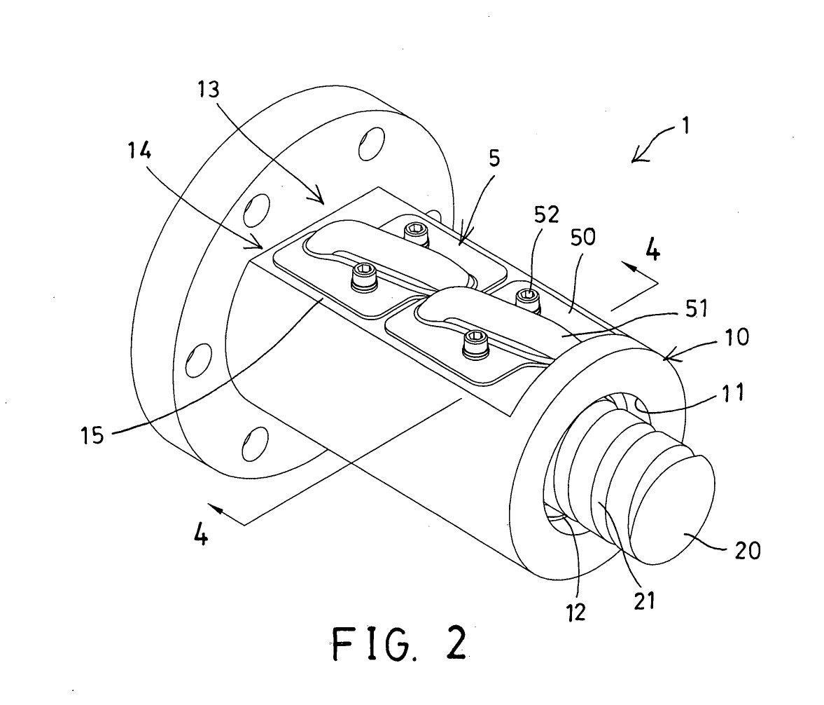

The ball screw device 1 further includes one or more (such as two) return device securing members or holders 5 each having a planar body or member 50 engaged onto the upper flat surface 15 of the nut member 10 (FIGS. 2, 4), and each having a swelling or retaining member 51 provided thereon or extended therefrom for engaging with the ball return devices 3 and for suitably anchoring or retaining or securing the ball return devices 3 to the nut member 10 respectively, and the planar body or members 50 of the return device holders 5 may be solidly secured to the nut member 10 with latches or fasteners 52. In addition, the planar members 50 of the return device holders 5 may be engaged with the flat upper surfaces 34 of the protrusions 33 of the ball return devices 3 (FIG. 4) for further solidly anchoring or retaining or securing the ball return devices 3 to the nut member 10 respectively.

The return device holders 5 each include a recess or compartment 53 formed in the retaining member 51 (FIG. 4) for receiving the central carrying member 30 and for further solidly anchoring or retaining or securing the ball return devices 3 to the nut member 10 and for preventing the ball return devices 3 from moving laterally or sidewise relative to the nut member 10 of the ball screw device 1. As shown in FIG. 5, the curved coupling portions 32 of the ball return devices 3 may be partially engaged in the notches 17 of the nut member 10 for allowing the ball return devices 3 to be closely secured to the nut member 10, and the curved coupling portions 32 of the ball return devices 3 are mostly engaged into the orifices 16 of the nut member 10 and located below the upper flat surface 15 of the nut member 10. Furthermore, the formation or the provision of the protrusion 33 at each end 31 of the ball return device 3 allows the ball return pathways 35 in the ball return devices 3 to have a greater curvature in order to guide the ball bearing members 80 to smoothly move through the endless ball guiding passages 22 of the ball screw device 1.

In operation, as shown in FIGS. 2-5, the protrusion 33 and the ends 31 of the ball return devices 3 may be suitably and stably engaged into the orifices 16 of the nut member 10 and stably anchored or secured or retained to the nut member 10, in addition, the planar members 50 of the return device holders 5 may be engaged with the flat surfaces 34 of the protrusions 33 of the ball return devices 3 for further solidly anchoring or retaining or securing the ball return devices 3 to the nut member 10 respectively. As shown in FIG. 1, it is preferable that the ball return devices 3 each include two substantially U-shaped supporting elements 36, 37, or the ball return devices 3 are each formed by two substantially U-shaped supporting elements 36, 37, such as an upper U-shaped supporting element 36 and a lower U-shaped supporting element 37, and the supporting elements 36, 37 each include about one half of the ball return pathway 35 formed therein. It is to be noted that the typical ball screw return systems failed to provide the enlarged protrusions 33 at the ends 31 of each ball return device 3 for being engaged with the planar members 50 of the return device holders 5.

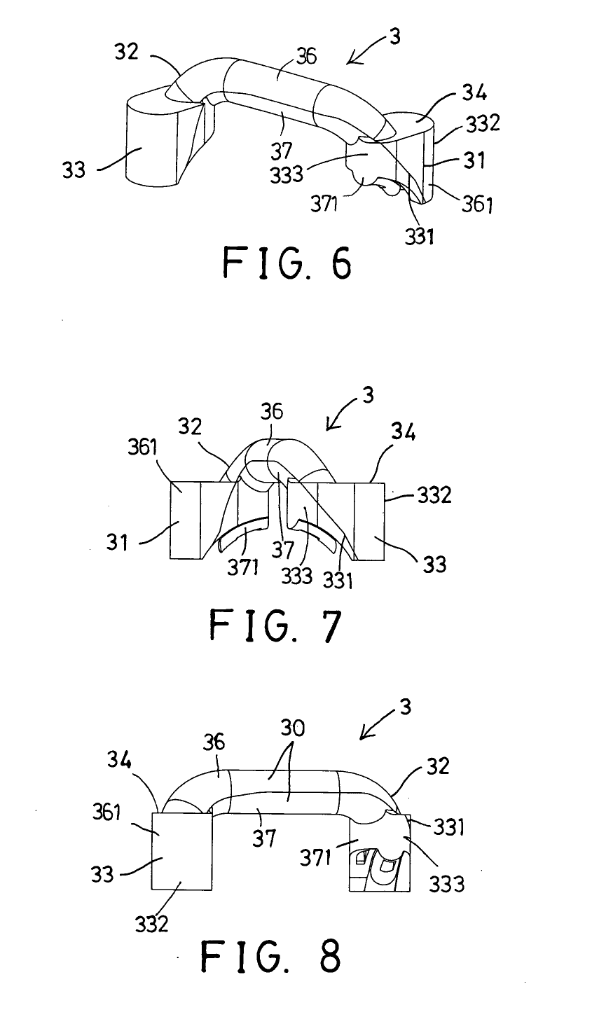

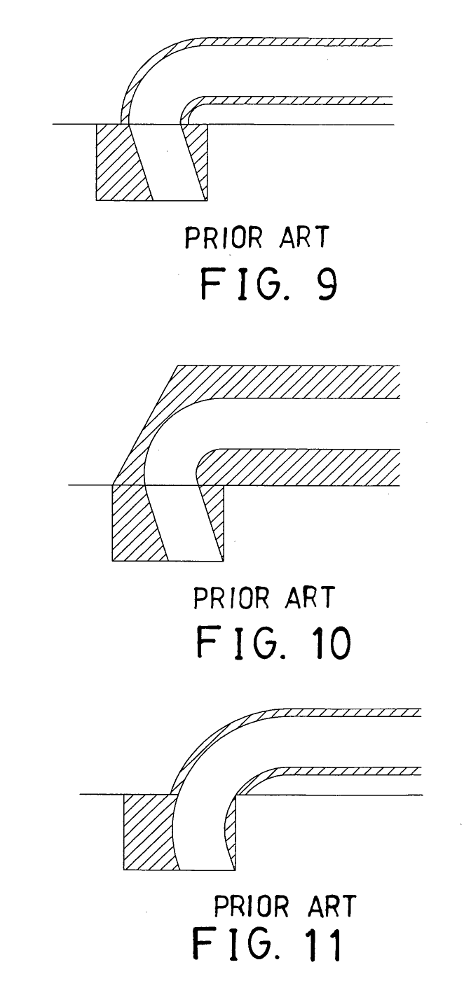

As shown in FIGS. 6-8, the curved coupling portions 32 of the ball return devices 3 each include a portion of the central carrying member 30 and a portion of the enlarged protrusion 33, and the enlarged protrusion 33 includes a portion of the curved ends of the ball return pathway 35, and the endless ball guiding pathway 35 of the ball return device 3 is curved in the protrusion 33 at the ends 31 of the ball return devices 3 or has a curvature formed in the protrusion 33 at the ends 31 of the ball return devices 3 (FIG. 5), such that the ball return pathways 35 in the ball return devices 3 may have a greater curvature in order to guide the ball bearing members 80 to smoothly move through the endless ball guiding passages 22 of the ball screw device 1. In addition, the curved coupling portions 32 of the ball return devices 3 may be partially engaged in the notches 17 of the nut member 10 for allowing the ball return devices 3 to be closely secured to the nut member 10. It is to be noted that the formation or the provision of the protrusion 33 at the ends 31 of the ball return devices 3 may suitably increase the ball returning angle or the curvature formed in the endless ball guiding pathway 35 of the ball return device 3 for allowing the ball bearing members 80 to smoothly or swiftly move through the endless ball guiding passage 35 of the ball return device 3.

Referring again to FIGS. 6-8, the protrusions 33 at the ends 31 of each ball return device 3 each include a curved or inclined or tilted cutting line or surface 331 formed therein for separating the respective protrusion 33 into two protrusion segments 361, 371, and each include an outer surface 332 and an inner surface 333, and the supporting elements 36, 37 of the ball return devices 3 each include the protrusion segments 361, 371 formed and provided at the end portions thereof. The curved coupling portions 32 of the upper U-shaped supporting element 36 each include a portion of the upper surface 34 of the protrusion 33 and a portion of the cutting surface 331 of the protrusion 33, and the curved coupling portions 32 of the lower U-shaped supporting element 37 each include a portion of the cutting surface 331 of the protrusion 33 and each include the inner surface 333 or a portion of the inner surface 333 formed or provided therein.

Accordingly, the ball return device in accordance with the present invention includes an anchoring or securing structure or device for suitably anchoring or securing or retaining the ball return device to the ball screw device and for suitably guiding the ball bearing members to smoothly move through the endless ball guiding passages of the ball screw device.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A ball screw device comprising:
a nut member including a screw hole formed therein and defined by a plurality of helical grooves, and including two orifices formed in said nut member and communicating with said helical grooves of said nut member, said nut member including two notches formed therein and communicating with said orifices of said nut member respectively,
an elongated screw engaged into said screw hole of said nut member and including a plurality of helical grooves for engaging with said helical grooves of said nut member and for forming an endless ball guiding passage between said nut member and said screw,
a plurality of ball bearing members engaged in said endless ball guiding passage of said ball screw device, and
a ball return device including a U-shaped structure having a central carrying member and two ends, and having two curved coupling portions formed between said central carrying member and said ends, and having a protrusion extended outwardly from each of said ends for engaging into said orifices of said nut member, each of said protrusions including an inner surface and an outer surface, and said ball return device including a ball return pathway formed therein and communicating with said helical grooves and said endless ball guiding passage of said nut member for slidably receiving said ball bearing members, said ball return pathway of said ball return device being curved in each of said protrusions for communicating with said helical grooves and said endless ball guiding passage of said nut member, said notches of said nut member being engaged with said curved coupling portions of said ball return device, and said ball return pathway of said ball return device being curved in said protrusions at said ends of said ball return device, and
said ball return device including a lower U-shaped supporting element and an upper U-shaped supporting element each having one half of said ball return pathway formed therein, said protrusions of said ball return device each including a cutting surface formed therein for separating said protrusion into two protrusion segments, and said upper and said lower supporting elements each including said protrusion segments formed at end portions thereof, said curved coupling portions of said upper supporting element each including a portion of said upper surface of said protrusion formed therein, and said curved coupling portions of said lower supporting element each including said inner surface of said protrusion formed therein.

2. The ball screw device as claimed in claim 1, wherein said nut member includes an upper surface, and said upper surfaces of said protrusions are aligned with said upper surface of said nut member.

3. The ball screw device as claimed in claim 2, wherein said nut member includes a cut off portion formed in an upper portion thereof and defined by said upper surface of said nut member.

4. The ball screw device as claimed in claim 3, wherein said orifices of said nut member are communicating with said cut off portion of said nut member.

5. The ball screw device as claimed in claim 2, wherein said curved coupling portions of said ball return device are engaged into said orifices of said nut member and located below said upper surface of said nut member.

6. The ball screw device as claimed in claim 1 further comprising a return device holder including a planar member engaged onto said nut member and engaged with said protrusions of said ball return device for retaining said ball return device to said nut member and for preventing said ball return device from moving laterally relative to said nut member.

7. The ball screw device as claimed in claim 6, wherein said return device holder includes a retaining member having a compartment formed therein for receiving said central carrying member.

8. The ball screw device as claimed in claim 1, wherein said curved coupling portions of said upper supporting element each include a portion of said cutting surface of said protrusion formed therein.

9. The ball screw device as claimed in claim 1, wherein said curved coupling portions of said lower supporting element each include a portion of said cutting surface of said protrusion formed therein.

10. The ball screw device as claimed in claim 1, wherein said protrusions of said upper supporting element each include said outer surface formed therein.
